(19) United States
(12) Patent Application Publication
(10) Pub. No.: US 2016/0195886 A1
(43) Pub. Date: Jul. 7, 2016

(54) ESTIMATED CONSUMPTION QUANTITY CALCULATION SYSTEM, SERVER, ESTIMATED CONSUMPTION QUANTITY CALCULATION METHOD, AND COMPUTER-READABLE RECORDING MEDIUM WHEREUPON PROGRAM IS RECORDED

(71) Applicant: NEC CORPORATION, Tokyo (JP)

(72) Inventors: Taku KONISHI, Tokyo (JP); Shinichi DOI, Tokyo (JP); Kouyou UEMURA, Tokyo (JP); Yuki KAMIYA, Tokyo (JP); Rie TANAKA, Tokyo (JP)

(21) Appl. No.: 14/910,877

(22) PCT Filed: Jun. 30, 2014
(86) PCT No.: PCT/JP2014/067335

§ 371 Date: Feb. 8, 2016

(30) Foreign Application Priority Data
Aug. 9, 2013 (JP) 2013-167083

(51) Int. Cl. G05F 1/66; G05B 15/02

(52) U.S. Cl. CPC G05F 1/66; G05B 15/02

(57) ABSTRACT

To calculate the estimated consumption quantity of each user in shared spaces each being usable at a time by multiple users so as to satisfy each user who has performed energy-saving behavior. A room with mild air conditioning and a room with strong air conditioning include respective air conditioners and respective sensors each of which senses a user entering and exiting the corresponding one of the rooms. A power consumption quantity information receiving unit of a server receives power consumption quantity information from each air conditioner. A user information receiving unit receives user information from each sensor. Based on mode information indicating a mode of calculation of an estimated consumption quantity and user information which are stored in a storage unit, a mode determination unit determines the calculation mode in such a way that the estimated consumption quantity of each user who has entered the room with mild air conditioning is to be smaller than the estimated consumption quantity of each user who has entered the room with strong air conditioning. An estimated consumption quantity computation unit computes the estimated consumption quantity by the calculation mode determined by the mode determination unit, based on the user information and the power consumption quantity information.

### TECHNICAL FIELD

The present invention relates to a technique for calculating an estimated energy consumption quantity consumed by an individual user in a shared space.

### BACKGROUND ART

Mechanisms for measuring the energy consumed in a space such as a house, a building, or an office floor (referred to as energy consumption below) and displaying (visualizing) the measured energy consumption are provided in order to encourage people to take such behavior as to save energy (referred to as energy-saving behavior below).

PTL 1 discloses an energy consumption quantity display system capable of easily obtaining the energy consumption quantity of each energy-consuming act. The energy consumption quantity display system disclosed in PTL 1 calculates the energy consumption quantity of individuals by measuring the time period of each person using each utility service (home appliance).

PTL 2 discloses an energy consumption management system providing, for example, fair billing based on the energy consumption quantity of each consumer by managing the energy consumption quantity of each of one or more unit-managed spaces used by multiple consumers. The energy consumption management system disclosed in PTL 2 determines, for each user, whether or not the user is in a unit-managed space of the management target (room or area), by use of a known technique using a card reader, based on image analysis or the like. In addition, the energy consumption management system disclosed in PTL 2 calculates the power consumption quantity of each user by dividing the power quantity consumed in a unit-managed space in a certain time period (power consumption quantity) by the number of consumers staying in the unit-managed spaces in the certain time period.

PTL 3 discloses an energy-saving support system which acquires the state of use of each electric appliance by each user and displays the acquired state of use to the user.

PTL 4 discloses a behavior-to-time ratio calculator which provides a user a guide for energy-saving behavior possible to perform while maintaining the behavior pattern of the user.

PTL 5 discloses an energy-saving support system which provides support for obtaining a successful energy-saving result. The energy-saving support system disclosed in PTL 5 increases awareness of working on energy saving of each person, such as an employee, by clearly displaying behavior to take in order to achieve energy saving and the result of energy saving.

PTL 6 discloses an energy consumption management apparatus which manages, at a certain business site, the state of energy resource consumption by each user using facility equipment.

### CITATION LIST

### Patent Literature

PTL 1: Japanese Unexamined Patent Application Publication No. 2011-248643

PTL 2: WO 2011/083684

PTL 3: Japanese Unexamined Patent Application Publication No. 2012-098963

PTL 4: Japanese Unexamined Patent Application Publication No. 2010-170419

PTL 5: Japanese Unexamined Patent Application Publication No. 2006-201029

PTL 6: Japanese Unexamined Patent Application Publication No. 2003-014492

### SUMMARY OF INVENTION

### Technical Problem

To succeed in energy saving in a shared space, such as a house, a building, or an office floor, it is necessary for the users using the shared space to actively work on energy saving. One possible way is to satisfy users working on energy saving by visualizing the energy consumption quantity consumed by each user in the shared space (referred to as an estimated consumption quantity below) and giving a preferential treatment to each user having a small estimated consumption quantity. Examples of a preferential treatment are to give an incentive to each user according to the estimated consumption quantity and to charge each user the energy use fee according to the estimated consumption quantity.

The energy consumption management system described in PTL 2 calculates the power consumption quantity of each user in each unit-managed space by simple per-capita division. Accordingly, when the number of users who have chosen a power-saving space (e.g., a room with an air conditioner set at a high temperature (room with mild air conditioning)) is larger than the number of users who have chosen a non-energy-saving space (e.g., a room with an air conditioner set at a low temperature (room with strong air conditioning)), the energy consumption management system may calculate each power consumption so that the power consumption quantity per user who has chosen the energy-saving space is higher than the power consumption quantity per user using the non-energy-saving space, in some cases. In such a case, the calculation result indicates that each user who has worked on energy saving has consumed more power than each user who has not worked on energy saving. Such a result is unfair for the users who have worked on energy saving, consequently making the users who have worked on energy saving unsatisfied. This may discourage the users from further working on power saving.

The energy consumption quantity display system disclosed in PTL 1 is, in the first place, not capable of calculating the energy consumption quantity related to an appliance used at a time by multiple users, such as an air conditioner or lighting.

None of the techniques of PTLs 3 to 6 satisfy any user who has taken energy-saving behavior in a shared space used at a time by multiple users.

The present invention has been made in view of the above-described circumstances and aims to calculate such an estimated consumption quantity of each user in a shared space used at a time by multiple users, as to satisfy users who have taken energy-saving behavior.

### Solution to Problem

A first aspect of the present invention is an estimated consumption quantity calculation system includes: apparatuses which are provided in respective shared spaces each being usable at a time by a plurality of users and have different energy consumption quantities; sensors each of which senses a user entering or exiting one of the shared spaces; and a server which is connected to the apparatuses and the sensors via a network. The server includes:

an energy consumption quantity information receiving unit which receives energy consumption quantity information indicating an energy consumption quantity per unit time from each of the apparatuses;

an entering/exiting information receiving unit which receives, from each of the sensors, entering/exiting information indicating a user entering or exiting a corresponding one of the shared spaces;

a storage unit which stores calculation method information indicating a calculation method for calculating an energy consumption quantity per unit time per user in each of the shared spaces as an estimated consumption quantity;

a calculation method determination unit which determines, based on the calculation method information and the entering/exiting information, the calculation method for calculating the estimated consumption quantity in such a way that the estimated consumption quantity of each user who has entered an energy-saving space, which is the shared space provided with the apparatus having a smaller energy consumption quantity than that of the apparatus provided in a different one of the shared spaces, is to be smaller than the estimated consumption quantity of each user who has entered a non-energy-saving space, which is the shared space provided with the apparatus having a larger energy consumption quantity than that of the apparatus provided in the energy-saving space; and

an estimated consumption quantity calculation unit which calculates the estimated consumption quantity of each user based on the entering/exiting information and the energy consumption quantity information by the calculation method determined by the calculation method determination unit.

A second aspect of the present invention is a server connected, via a network, to apparatuses which are provided in respective shared spaces each being usable at a time by a plurality of users and have different energy consumption quantities, and sensors each of which senses a user entering or exiting a corresponding one of the shared spaces. The server includes:

an energy consumption quantity information receiving unit which receives energy consumption quantity information indicating an energy consumption quantity per unit time from each of the apparatuses;

an entering/exiting information receiving unit which receives, from each of the sensors, entering/exiting information indicating a user entering or exiting a corresponding one of the shared spaces;

a storage unit which stores calculation method information indicating a calculation method for calculating an energy consumption quantity per unit time per user in each of the shared spaces as an estimated consumption quantity;

a calculation method determination unit which determines, based on the calculation method information and the entering/exiting information, the calculation method for calculating the estimated consumption quantity in such a way that the estimated consumption quantity of each user who has entered an energy-saving space, which is the shared space provided with the apparatus having a smaller energy consumption quantity than that of the apparatus provided in a different one of the shared spaces, is to be smaller than the estimated consumption quantity of each user who has entered a non-energy-saving space, which is the shared space provided with the apparatus having a larger energy consumption quantity than that of the apparatus provided in the energy-saving space; and

an estimated consumption quantity calculation unit which calculates the estimated consumption quantity of each user based on the entering/exiting information and the energy consumption quantity information by the calculation method determined by the calculation method determination unit.

A third aspect of the present invention is an estimated consumption quantity calculation method executed by a server connected, via a network, to apparatuses which are provided in respective shared spaces each being usable at a time by a plurality of users and have different energy consumption quantities, and sensors each of which senses a user entering or exiting a corresponding one of the shared spaces. The method includes:

an energy consumption quantity information receiving step of receiving energy consumption quantity information indicating an energy consumption quantity per unit time from each of the apparatuses;

an entering/exiting information receiving step of receiving, from each of the sensors, entering/exiting information indicating a user entering or exiting a corresponding one of the shared spaces;

a calculation method determination step of determining, based on calculation method information indicating a calculation method for calculating an energy consumption quantity per unit time per user in each of the shared spaces as an estimated consumption quantity and the entering/exiting information, the calculation method for calculating the estimated consumption quantity in such a way that the estimated consumption quantity of each user who has entered an energy-saving space, which is the shared space provided with the apparatus having a smaller energy consumption quantity than that of the apparatus provided in a different one of the shared spaces, is to be smaller than the estimated consumption quantity of each user who has entered a non-energy-saving space, which is the shared space provided with the apparatus having a larger energy consumption quantity than that of the apparatus provided in the energy-saving space; and

an estimated consumption quantity calculation unit which calculates the estimated consumption quantity of each user based on the entering/exiting information and the energy consumption quantity information by the calculation method determined in the calculation method determination step.

A fourth aspect of the present invention is a computer-readable recording medium storing a program for causing a computer connected, via a network, to apparatuses which are provided in respective shared spaces each usable at a time by a plurality of users and have different energy consumption quantities, and sensors each of which senses a user entering or exiting a corresponding one of the shared spaces, to function as:

an energy consumption quantity information receiving unit which receives energy consumption quantity information indicating an energy consumption quantity per unit time from each of the apparatuses;

an entering/exiting information receiving unit which receives, from each of the sensors, entering/exiting information indicating a user entering or exiting a corresponding one of the shared spaces;

a storage unit which stores calculation method information indicating a calculation method for calculating an energy consumption quantity per unit time per user in each of the shared spaces as an estimated consumption quantity;

a calculation method determination unit which determines, based on the calculation method information and the entering/exiting information, the calculation method for calculating the estimated consumption quantity in such a way that the estimated consumption quantity of each user who has entered an energy-saving space, which is the shared space provided with the apparatus having a smaller energy consumption quantity than that of the apparatus provided in a different one of the shared spaces, is to be smaller than the estimated consumption quantity of each user who has entered a non-energy-saving space, which is the shared space provided with the apparatus having a larger energy consumption quantity than that of the apparatus provided in the energy-saving space; and

an estimated consumption quantity calculation unit which calculates the estimated consumption quantity of each user based on the entering/exiting information and the energy consumption quantity information by the calculation method determined by the calculation method determination unit.

### Advantageous Effects of Invention

According to the present invention, it is possible to calculate such an estimated consumption quantity of each user in a shared space being usable at a time by multiple users, as to satisfy users who have performed energy-saving behavior.

### BRIEF DESCRIPTION OF DRAWINGS

FIG. 1 is a diagram illustrating an estimated consumption quantity calculation system according to an exemplary embodiment.

FIG. 2 is a block diagram for illustrating functions of a server according to the exemplary embodiment.

FIG. 3 is diagram illustrating first-mode information according to the exemplary embodiment.

FIG. 4 is a diagram illustrating second-mode information according to the exemplary embodiment.

FIG. 5 is a diagram for illustrating switching of calculation modes according to the exemplary embodiment.

FIG. 6 is a flowchart of an estimated consumption quantity calculation process according to the exemplary embodiment.

FIG. 7 is a block diagram for illustrating a hardware configuration of the server according to the exemplary embodiment.

### DESCRIPTION OF EMBODIMENTS

Exemplary embodiments of the present invention are described below in detail with reference to the drawings. The same or corresponding parts are denoted by the same reference signs throughout the drawings.

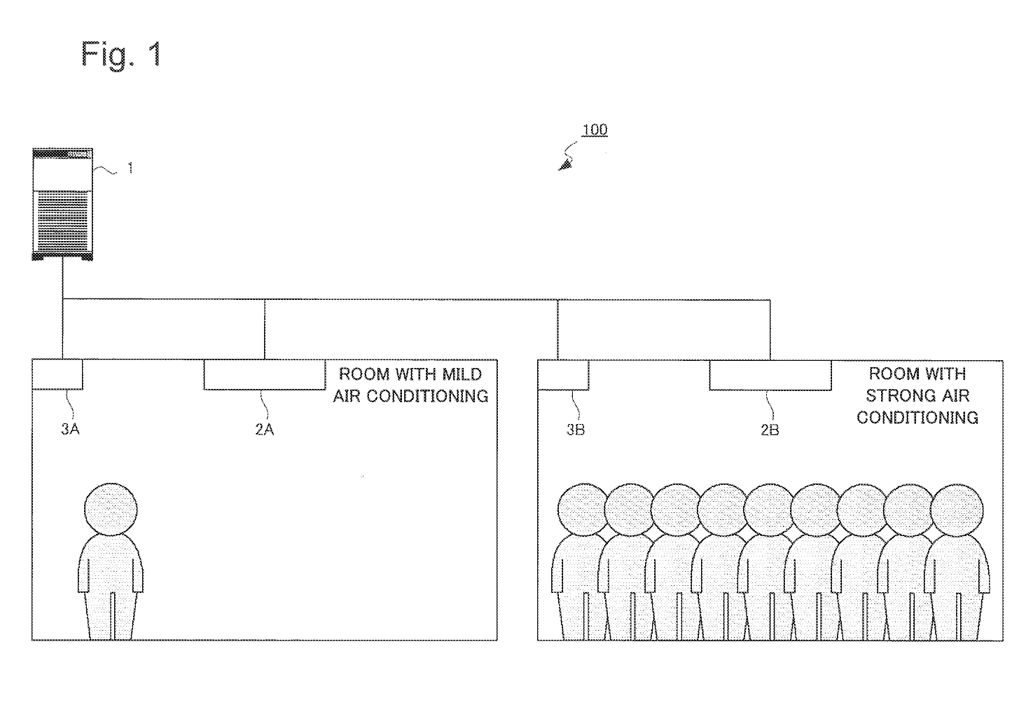

As illustrated in FIG. 1, an estimated consumption quantity calculation system 100 includes a server 1, an air conditioner 2A, an air conditioner 2B, a sensor 3A, and a sensor 3B. The server 1, the air conditioner 2A, the air conditioner 2B, the sensor 3A, and the sensor 3B are connected to each other via a network.

Each of the air conditioner 2A and the air conditioner 2B adjusts indoor environment, such as the temperature and the humidity. Each of the air conditioner 2A and the air conditioner 2B generates power consumption quantity information (energy consumption quantity information) indicating the power consumption quantity (energy consumption quantity) per unit time and transmits the power consumption quantity information to the server 1. FIG. 1 illustrates a room with mild air conditioning (a room with an air conditioner for cooling set at a high temperature) and a room with strong air conditioning (a room with an air conditioner for cooling set at a low temperature). The room with mild air conditioning and the room with strong air conditioning include the air conditioner 2A and the air conditioner 2B, respectively. The power quantity consumed by the air conditioner 2A in the room with mild air conditioning is smaller than the power quantity consumed by the air conditioner 2B in the room with strong air conditioning. Note that, in this exemplary embodiment, the room with mild air conditioning is a power-saving space, and the room with strong air conditioning is a non-power-saving space (a space which is not for specially aiming at power saving).

Each of the sensor 3A and the sensor 3B includes an integrated circuit (IC) tag reader and reads, from the IC tag held by each user, the information identifying the user (referred to as user identification information below) to sense the user entering and exiting the corresponding room, by use of the IC tag reader. In addition, each of the sensor 3A and the sensor 3B generates user information associating the user identification information and entering/exiting information indicating the user entering or exiting the corresponding room and transmits the user information to the server 1. As illustrated in FIG. 1, the sensor 3A is installed in the room with mild air conditioning, and the sensor 3B is installed in the room with strong air conditioning.

The server 1 determines a mode of the calculation (calculation method) of the power consumption quantity per unit time per user who has entered the room with mild air conditioning (who has chosen the room with mild air conditioning) (estimated consumption quantity), on the basis of the power consumption quantity information (energy consumption quantity information) received from the air conditioner 2A and the user information received from the sensor 3A, and the power consumption quantity per unit time per user who has entered the room with strong air conditioning (estimated consumption quantity), on the basis of the power consumption quantity information (energy consumption quantity information) received from the air conditioner 2B and the user information received from the sensor 3B. The server 1 determines a mode of the calculation of each of the estimated consumption quantity so that the estimated consumption quantity of each user who has entered the room with mild air conditioning is to be smaller than the estimated consumption quantity of each user who has entered the room with strong air conditioning. The server 1 computes the estimated consumption quantity of each user in the determined calculation mode and outputs (visualizes) the estimated consumption quantity thus computed.

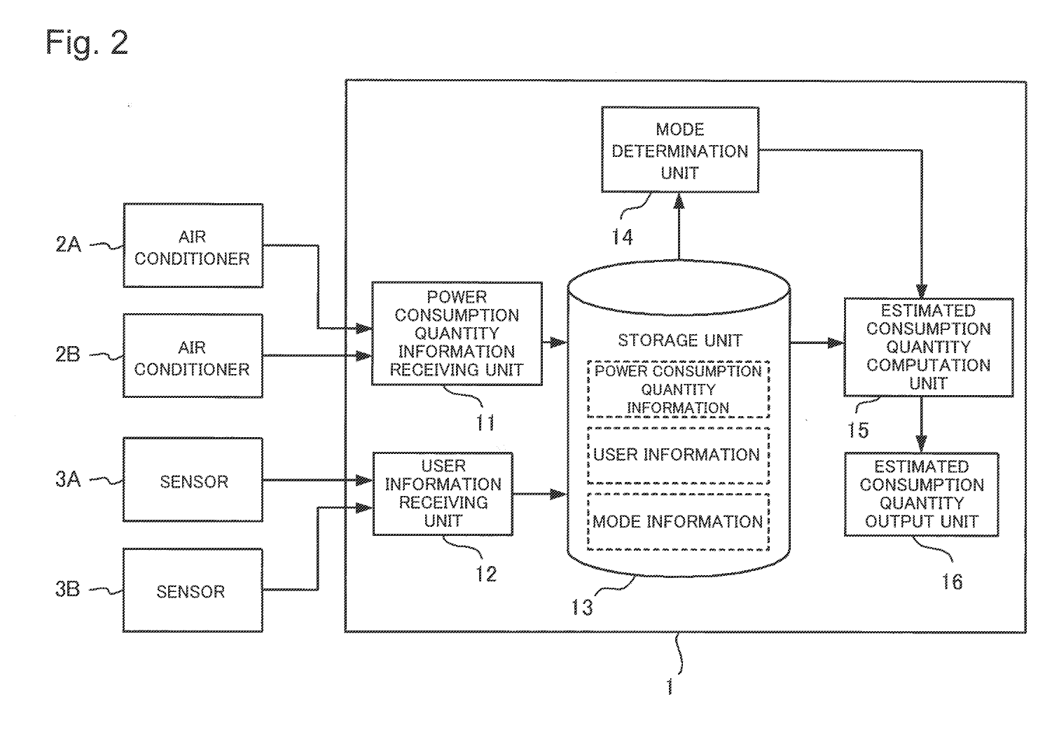

The server 1 illustrated in FIG. 2 includes a power consumption quantity information receiving unit (energy consumption quantity information receiving unit) 11, a user information receiving unit (entering/exiting information receiving unit) 12, a storage unit 13, a mode determination unit (calculation method determination unit) 14, an estimated consumption quantity computation unit (estimated consumption quantity calculation unit) 15, and an estimated consumption quantity output unit 16.

The power consumption quantity information receiving unit 11 receives, from each of the air conditioner 2A and the air conditioner 2B, power consumption quantity information indicating the power consumption quantity consumed by the corresponding one of the air conditioner 2A and the air conditioner 2B. The power consumption quantity information receiving unit 11 stores the received power consumption quantity information in the storage unit 13.

The user information receiving unit 12 receives user information indicating a user entering or exiting the room with mild air conditioning from the sensor 3A and user information indicating a user entering or exiting the room with strong air conditioning from the sensor 3B. The user information receiving unit 12 stores the received user information in the storage unit 13.

The storage unit 13 stores, in advance, mode information (calculation method information) indicating a mode of calculating an estimated consumption quantity (calculation method). The storage unit 13 also stores power consumption quantity information provided by each of the air conditioner 2A and the air conditioner 2B and user information provided by each of the sensor 3A and the sensor 3B.

When the user information receiving unit 12 receives user information indicating a user entering one of the rooms, the mode determination unit 14 determines a mode of calculating the estimated consumption quantity, on the basis of the user information and the mode information stored in the storage unit 13. Here, the mode determination unit 14 determines the calculation mode so that the estimated consumption quantity of each user who has entered the room with mild air conditioning is to be smaller than the estimated consumption quantity of each user who has entered the room with strong air conditioning. The mode determination unit 14 transmits mode information indicating the determined calculation mode, to the estimated consumption quantity computation unit 15.

The estimated consumption quantity computation unit 15 computes the estimated consumption quantity of the user in the calculation mode indicated by the mode information received from the mode determination unit 14, on the basis of the user information and the power consumption quantity information stored in the storage unit 13. The estimated consumption quantity computation unit 15 transmits estimated consumption quantity information indicating the estimated consumption quantity thus computed, to the estimated consumption quantity output unit 16.

The estimated consumption quantity output unit 16 outputs the estimated consumption quantity information received from the estimated consumption quantity computation unit 15. A method to be employed to output the estimated consumption quantity information may be, for example, a method in which the estimated consumption quantity output unit 16 transmits the estimated consumption quantity information to a terminal of the user via a network or a method of displaying the estimated consumption quantity information on the screen of the server 1. Alternatively, the method to be employed to output the estimated consumption quantity information may be a method in which the estimated consumption quantity output unit 16 outputs voice expressing the estimated consumption quantity. The estimated consumption quantity computation unit 15 may store the estimated consumption quantity information in the storage unit 13. In this case, to find out the estimated consumption quantity, the user can browse the estimated consumption quantity information by accessing the server 1. The estimated consumption quantity output unit 16 may also output the calculation mode information indicating the calculation mode determined by the mode determination unit 14, in addition to the estimated consumption quantity information.

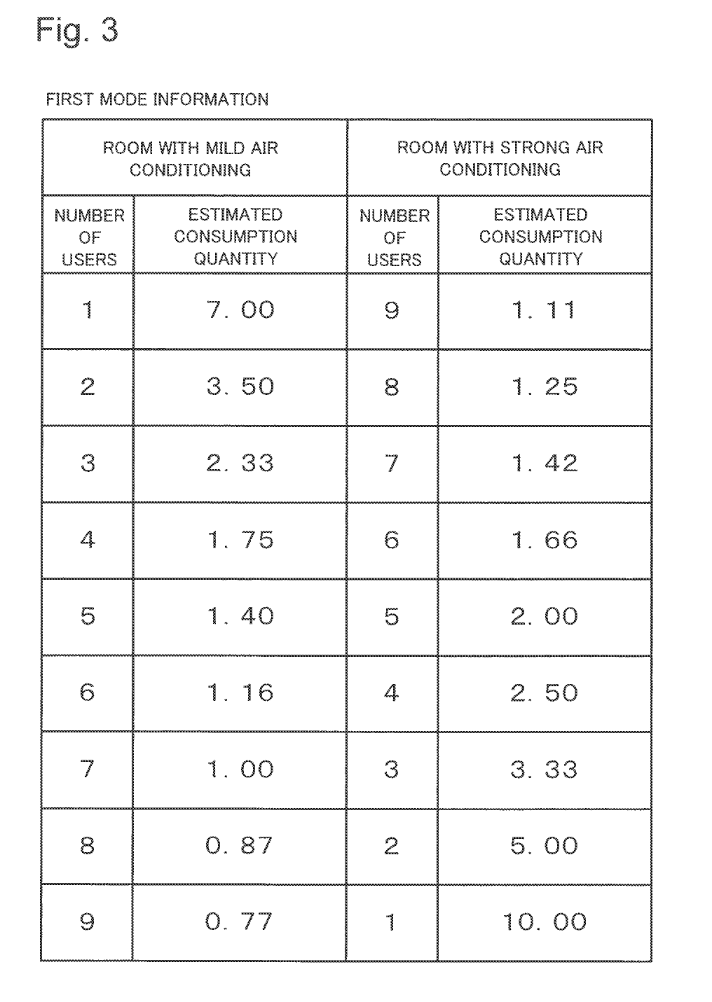

The method of determining a mode of the calculation of an estimated consumption quantity is specifically described below with respect to FIGS. 3 to 5. Here, it is assumed that the total number of users is 10, and that the power consumption quantity per unit time in the room with mild air conditioning is 7 kWh and the power consumption quantity per unit time in the room with strong air conditioning is 10 kWh.

As illustrated in FIG. 3, in a first mode (first calculation method) indicated by first mode information, the estimated consumption quantity computation unit 15 computes the estimated consumption quantity of each user by dividing the power consumption quantity of each room per unit time by the number of users in the room.

The formula for the first mode is: in the case of the room with mild air conditioning, 7 (kWh)/the number of users in the room with mild air conditioning; and in the case of the room with strong air conditioning, 10 (kWh)/the number of users in the room with strong air conditioning.

In the case of the first mode, assume that the number of users in the room with mild air conditioning is smaller than half the total of the number of users (total number of users) who have chosen the room with mild air conditioning and the number of users who have chosen the room with strong air conditioning. In this case, the estimated consumption quantity of each user who has chosen the room with mild air conditioning, which is considered as power-saving behavior, is larger than the estimated consumption quantity of each user who has chosen the room with strong air conditioning, which is considered as non-power-saving behavior.

For example, when the number of users in the room with mild air conditioning is one and the number of users in the room with strong air conditioning is nine as illustrated in FIG. 1, the estimated consumption quantity of each user in the room with mild air conditioning is 7.00 kWh whereas the estimated consumption quantity of each user in the strong air conditioning is 1.11 kWh. This means that, in the first mode, when the number of users in the room with mild air conditioning is smaller than half the total number of users, the estimated consumption quantity of each user who has entered the room with mild air conditioning for power saving results in being larger than the estimated consumption quantity of each user who has entered the room with strong air conditioning. Accordingly, each user who has entered the room with mild air conditioning is, although performing power-saving behavior, considered to have consumed more power than that of each user not performing power-saving behavior (user who has entered the room with strong air conditioning). Such estimation does not satisfy any user who has entered the room with mild air conditioning. To address this problem, a second mode (second calculation method) is prepared.

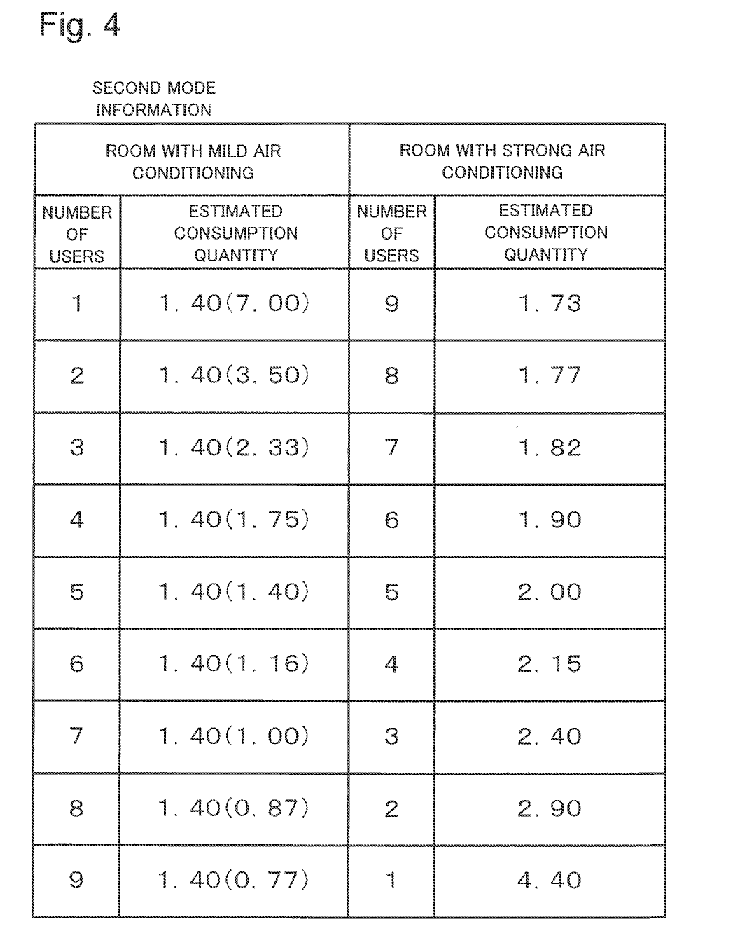

As illustrated in FIG. 4, in the second mode indicated by second mode information, the estimated consumption quantity of each user who has entered the room with mild air conditioning is 1.40 kWh irrespective of the number of users who have entered the room with mild air conditioning. This value is obtained by dividing the total of the power consumption quantities per unit time of the room with mild air conditioning and the room with strong air conditioning by the total of the number of users who have entered the room with mild air conditioning and the number of users who have entered the room with strong air conditioning, under the assumption that the power consumption quantity per unit time of the room with strong air conditioning is 7 kWh, which is the same power consumption quantity per unit time of the room with mild air conditioning.

The estimated consumption quantity of each user who has entered the room with strong air conditioning is obtained in the following procedure. First, obtain the product of the estimated consumption quantity of each user who has entered the room with mild air conditioning and the number of users who have entered the room with mild air conditioning (total of the estimated consumption quantities of the users in the room with mild air conditioning). Then, obtain a value (total of the estimated consumption quantities of the users in the room with the strong air conditioning) by subtracting the total of the estimated consumption quantities of the users in the room with mild air conditioning from the total power consumption quantity (total energy consumption quantity) of the room with mild air conditioning and the room with strong air conditioning. Then, obtain a value by dividing the total of the estimated consumption quantities of the users in the room with strong air conditioning by the number of users in the room with strong air conditioning. The value thus obtained is the estimated consumption quantity of each user who has entered the room with strong air conditioning.

The formula for the second mode is: in the case of the room with mild air conditioning, (7+7) (kWh)/total number of users; and in the case of the room with strong air conditioning, {(7+10) (kWh) −(7+7) (kWh)/total number of users×number of users in the room with mild air conditioning}/number of users in the room with strong air conditioning.

When an estimated consumption quantity is obtained by use of the formula for the second mode as described above, the estimated consumption quantity of each user who has chosen the room with mild air conditioning results in being smaller than the estimated consumption quantity of each user who has chosen the room with strong air conditioning, irrespective of the number of users who have chosen the room with mild air conditioning. Accordingly, even when the number of users who have chosen the room with mild air conditioning is smaller than half the total number of users, the estimated consumption quantity of each user who has chosen the room with mild air conditioning for power saving is smaller than the estimated consumption quantity of each user who has chosen the room with strong air conditioning.

However, when the number of users who have chosen the room with mild air conditioning is larger than half the total number of users, the estimated consumption quantity of each user who has chosen the room with mild air conditioning, which is obtained by use of the formula for the second mode results in being larger than the estimated consumption quantity of each user who has chosen the room with mild air conditioning, which is obtained by use of the formula for the first mode (value in the corresponding pair of parentheses as illustrated in FIG. 4). In other words, the estimated consumption quantity of each user who has chosen the room with mild air conditioning is larger than the power quantity actually consumed per user in the room with mild air conditioning. Such estimation discourages the users from working on energy saving.

In order to appropriately compute an estimated consumption quantity according to the number of users who have chosen the room with mild air conditioning, the calculation modes need to be switched depending on whether the number of users who have chosen the room with mild air conditioning is smaller than or larger than half the total number of users.

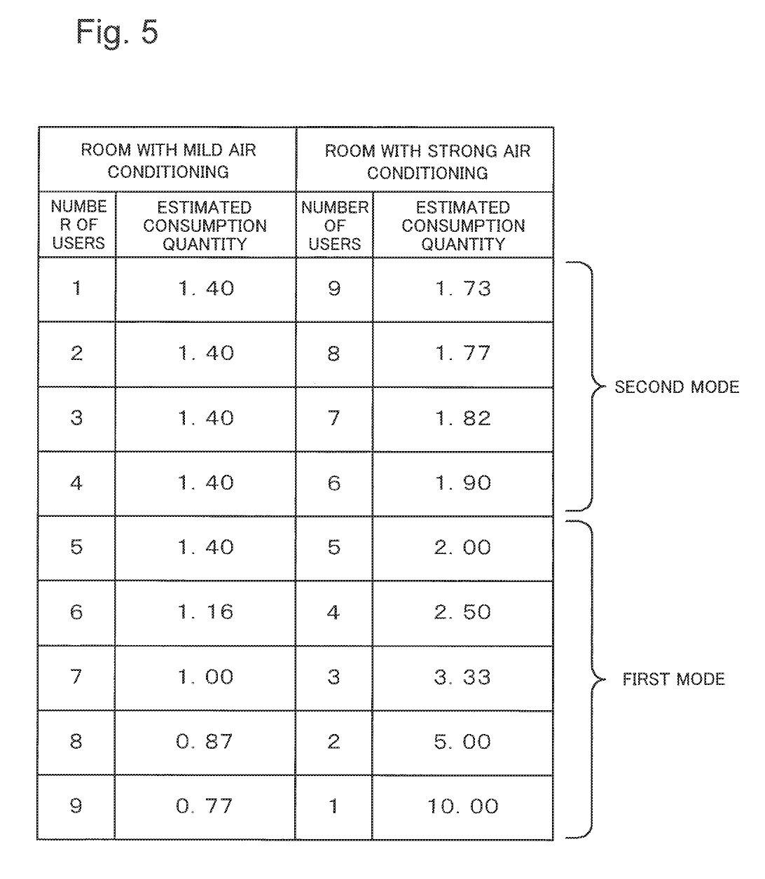

A method of computing an estimated consumption quantity while switching between calculation modes is described below with reference to FIG. 5.

The mode determination unit 14 determines a mode to employ so that the estimated consumption quantity of each user who has chosen the room with mild air conditioning, which is energy-saving behavior, is to be always smaller than the estimated consumption quantity of each user who has chosen the room with strong air conditioning. To enable this, the mode determination unit 14 determines the second mode as the mode of the calculation of an estimated consumption quantity when the number of users who have chosen the room with mild air conditioning is smaller than half the total number of users. In contrast, when the number of users who have chosen the room with mild air conditioning is larger than or equal to half the total number of users, the mode determination unit 14 determines the first mode as the mode of the calculation of an estimated consumption quantity.

When the number of users who have chosen the room with strong air conditioning is smaller than or equal to half the total number of users, the mode determination unit 14 determines the first mode as the mode of the calculation of an estimated consumption quantity. In contrast, when the number of users who have chosen the room with strong air conditioning is larger than half the total number of users, the mode determination unit 14 determines the second mode as the mode of the calculation of an estimated consumption quantity.

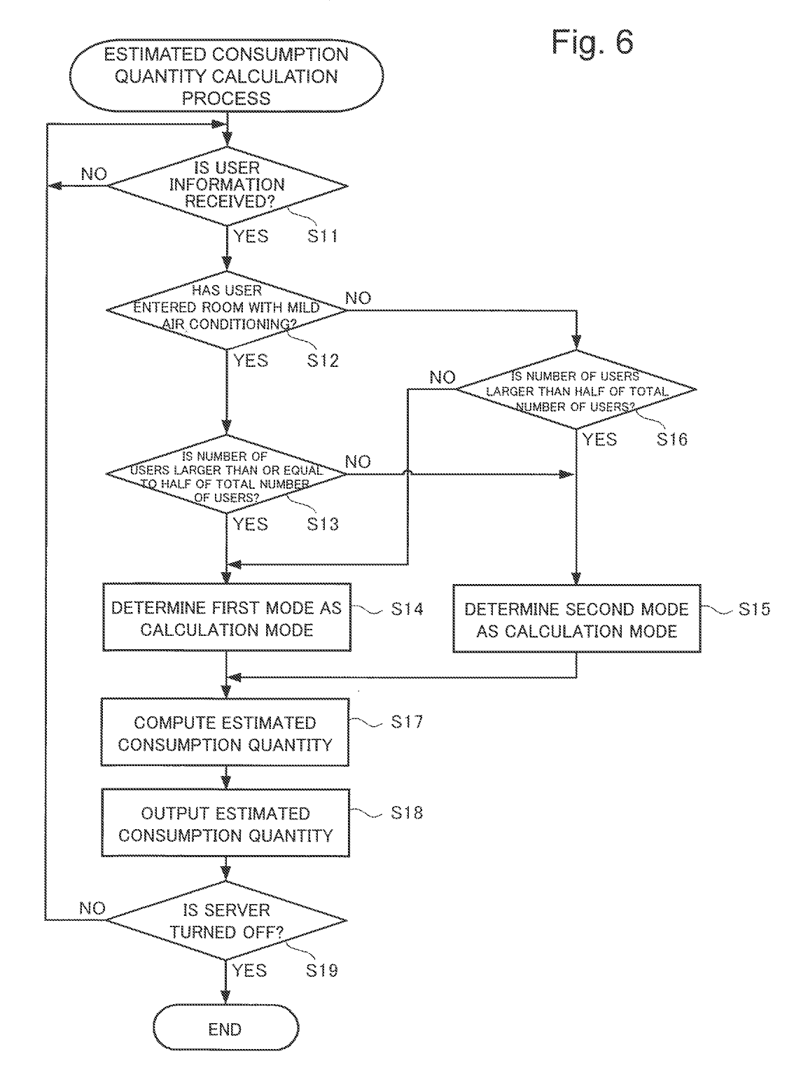

Next, an estimated consumption quantity calculation process carried out by the server 1 according to this exemplary embodiment is described with reference to the flowchart presented in FIG. 6. The server 1 carries out the estimated consumption quantity calculation process when the server 1 is turned on.

First, the user information receiving unit 12 determines whether or not user information has been received from the sensor 3A or the sensor 3B (Step S11). When the user information receiving unit 12 determines that user information has not been received (No in Step S11), the user information receiving unit 12 repeats the process in Step S11.

In contrast, when the user information receiving unit 12 determines that user information has been received (Yes in Step S11), the user information receiving unit 12 stores the received user information in the storage unit 13 and passes the control to the mode determination unit 14.

When the control is passed to the mode determination unit 14, the mode determination unit 14 determines whether or not the room which the corresponding user has entered is the room with mild air conditioning (Step S12).

When the mode determination unit 14 determines that the room which the user has entered is the room with mild air conditioning (Yes in Step S12), the mode determination unit 14 determines whether or not the number of users in the room with mild air conditioning is larger than or equal to half the total number of users, on the basis of the user information stored in the storage unit 13 (Step S13).

When the mode determination unit 14 determines that the number of users in the room with mild air conditioning is larger than or equal to half the total number of users (Yes in Step S13), the mode determination unit 14 determines the first mode as the mode of the calculation of an estimated consumption quantity (Step S14). In contrast, when the mode determination unit 14 determines that the number of users in the room with mild air conditioning is smaller than half the total number of users (No in Step S13), the mode determination unit 14 determines the second mode as the mode of the calculation of an estimated consumption quantity (Step S15).

Assume that, in Step S12, the mode determination unit 14 determines that the room which the user has entered is not the room with mild air conditioning (or is the room with strong air conditioning) (No in Step S12). In this case, the mode determination unit 14 determines whether or not the number of users in the room with strong air conditioning is larger than half the total number of users, on the basis of the user information stored in the storage unit 13 (Step S16).

When the mode determination unit 14 determines that the number of users in the room with strong air conditioning is larger than half the total number of users (Yes in Step S16), the mode determination unit 14 determines the second mode as the mode of the calculation of an estimated consumption quantity (Step S15). In contrast, when the mode determination unit 14 determines that the number of users in the room with strong air conditioning is not larger than half the total number of users (or is smaller than or equal to half the total number of users) (No in Step S16), the mode determination unit 14 determines the first mode as the mode of the calculation of an estimated consumption quantity (Step S14). After the determination, the mode determination unit 14 transmits mode information indicating that the determined calculation mode is the first mode or the second mode, to the estimated consumption quantity computation unit 15.

The estimated consumption quantity computation unit 15 receives the mode information and computes an estimated consumption quantity on the basis of the received mode information as well as the user information and the power consumption quantity information stored in the storage unit 13, by use of the formula corresponding to the calculation mode indicated by the mode information (Step S17). The estimated consumption quantity computation unit 15 transmits estimated consumption quantity information indicating the estimated consumption quantity thus computed, to the estimated consumption quantity output unit 16.

The estimated consumption quantity output unit 16 receives the estimated consumption quantity information and outputs the estimated consumption quantity information thus received, to a terminal of the user via a network, for example (Step S18).

After the output, the estimated consumption quantity output unit 16 determines whether or not the server 1 is turned off (Step S19). When the estimated consumption quantity output unit 16 determines that the server 1 is not turned off (or is still on) (No in Step S19), the process returns to Step S11, and Steps S11 to S19 are repeated. In contrast, when the estimated consumption quantity output unit 16 determines that the server 1 is turned off (Yes in Step S19), the estimated quantity computation process is terminated.

As described above, the estimated consumption quantity calculation system 100 according to this exemplary embodiment appropriately switches between the calculation modes according to the ratio of the number of users who have chosen the energy-saving space to the total number of users so that the estimated consumption quantity of each user who has chosen the energy-saving space is to be smaller than the estimated consumption quantity of each user who has chosen the non-energy-saving space. In this way, the estimated consumption quantity computation system 100 can compute such an estimated consumption quantity of each user as to satisfy the users who have performed the energy-saving behavior. Consequently, the users are encouraged to perform energy-saving behavior.

In the above-described exemplary embodiment, each of the air conditioner 2A and the air conditioner 2B transmits, to the server 1, the power consumption quantity information indicating the power consumption quantity per unit time. However, the apparatuses that transmit power consumption quantity information to the server 1 are not limited to air conditioners, and may be any apparatuses each used at a time by multiple users, for example, lighting or office equipment.

In the above-described exemplary embodiment, description is given of the example in which the power consumption of one of the apparatuses installed in each of the shared spaces (the room with mild air conditioning and the room with strong air conditioning) is to be measured. However, in the present invention, the power consumption measurement target in each shared space may be multiple ones of the apparatuses installed in the shared space. For example, the power consumption measurement target may be the lighting and the air conditioner installed in the room with mild air conditioning. When the power consumption measurement target includes multiple ones of the apparatuses installed in each shared space, power consumption quantity information transmitted to the server 1 indicates the total of the power consumption quantities per unit time of the respective apparatuses serving as the power consumption measurement target in the shared space.

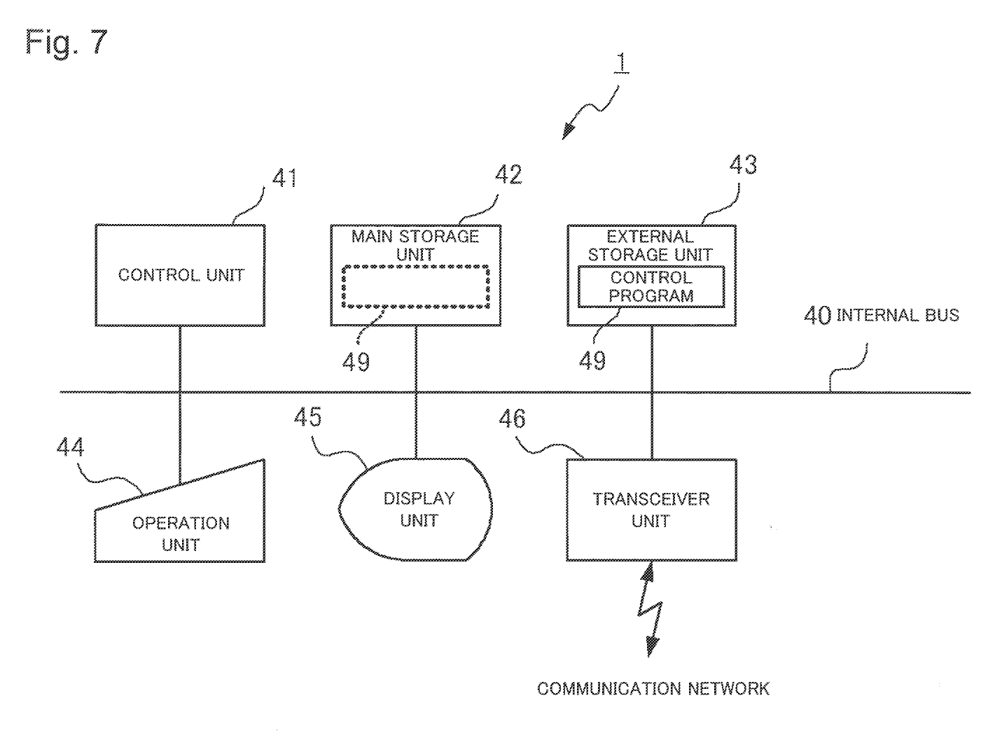

Next, a hardware configuration of the server 1 is described. As illustrated in FIG. 7, the server 1 includes a control unit 41, a main storage unit 42, an external storage unit 43, an operation unit 44, a display unit 45, and a transceiver unit 46. The control unit 41, the main storage unit 42, the external storage unit 43, the operation unit 44, the display unit 45, and the transceiver unit 46 are connected to each other via an internal bus 40.

The control unit 41 includes a central processing unit (CPU) and the like and carries out processes according to a control program 49 stored in the external storage unit 43. The control unit 41 carries out, for example, the process carried out by the mode determination unit 14 of the server 1, the process carried out by the estimated consumption quantity computation unit 15 of the server 1 and the like.

The main storage unit 42 includes a random-access memory (RAM) and is used as a work area of the control unit 41 by loading the control program 49 stored in the external storage unit 43.

The external storage unit 43 includes a hard disk and stores power consumption quantity information provided by each of the air conditioner 2A and the air conditioner 2B, user information provided by each of the sensor 3A and the sensor 3B, and mode information indicating each calculation mode for calculating an estimated consumption quantity. The external storage unit 43 stores the control program 49 for causing the control unit 41 to carry out various processes including the estimated consumption quantity calculation process. The external storage unit 43 may include a nonvolatile memory such as a flash memory, a digital versatile disc random-access memory (DVD-RAM), a digital versatile disc rewritable (DVD-RW) or the like, instead of a hard disk. The storage unit 13 included in the server 1 is configured by the external storage unit 43.

The operation unit 44 includes a keyboard, a pointing device or the like, such as a mouse, and an interface device for connecting the keyboard and the pointing device or the like to the internal bus 40. Upon input of information, such as mode information, by a user operation, the operation unit 44 provides an instruction based on the input information to the control unit 41.

The display unit 45 includes, for example, a cathode ray tube (CRT), a liquid crystal display (LCD) or the like and displays information provided by the control unit 41. The display unit 45 displays various operation screens via which each user inputs information, such as mode information, to the server 1. The display unit 45 also displays estimated consumption quantity information. For the display, the display unit 45 functions as the estimated consumption quantity output unit 16.

The transceiver unit 46 includes a network termination or a wireless communication device connected to a communication network, and a serial interface or a local area network (LAN) interface connected to the network termination or the wireless communication device. The transceiver unit 46 functions as the power consumption quantity information receiving unit 11 and the user information receiving unit 12 of the server 1. The server 1 may be connected to each of the air conditioner 2A, the air conditioner 2B, the sensor 3A, and the sensor 3B with a cable. When the estimated consumption quantity output unit 16 transmits estimated consumption quantity information to a terminal of a corresponding user, the transceiver unit 46 functions as the estimated consumption quantity output unit 16.

The control unit 41 executes a corresponding one of the processes to be carried out by the power consumption quantity information receiving unit 11, the user information receiving unit 12, the storage unit 13, the mode determination unit 14, the estimated consumption quantity computation unit 15, and the estimated consumption quantity output unit 16 included in the server 1 illustrated in FIG. 2, according to an instruction from the control program 49. For the execution, the control unit 41 uses the main storage unit 42, the external storage unit 43, the operation unit 44, the display unit 45, the transceiver unit 46, and the like as computer resources.

Note that the above-described hardware configuration and flowchart are merely examples, and that any changes and modifications may be arbitrarily made to the hardware configuration and flowchart without departing from the gist of the present invention.

The primary part for the estimated consumption quantity calculation process including the control unit 41, the main storage unit 42, the external storage unit 43, the operation unit 44, the internal bus 40, and the like is implementable by use of an ordinary computer system without using any specifically designed system. For example, the server 1 capable of executing the above-described processes may be configured by: distributing a computer program for performing the above operations, in the form of being stored in a computer-readable storage medium (such as a flexible disk, a compact disc read only memory (CD-ROM), a digital versatile disk read only memory (DVD-ROM) or the like); and installing the computer program in a computer. Alternatively, the server 1 may be configured by storing the computer program in a storage device included in a computer on a communication network, such as the Internet, and, for example, downloading the computer program by use of an ordinary computer system.

When the functions of the estimated consumption quantity calculation system 100 are performed, for example, by an operating system (OS) and an application program sharing responsibility or cooperating with each other, only the application program part may be stored in a recording medium or a storage device.

The computer program may be distributed via a communication network in the form of being superimposed on a carrier. For example, the computer program may be posted on a bulletin board system (BBS) on a communication network and distributed via the communication network. In this case, the above-described processes may be carried out by starting the computer program and executing the computer program under the control of the OS as in the case of other application programs.

Part of or all of the above-described exemplary embodiments may be described as the following supplementary notes but are not limited to the supplementary notes.

(Supplementary Note 1) An estimated consumption quantity calculation system comprising: apparatuses which are provided in respective shared spaces each being usable at a time by a plurality of users and have different energy consumption quantities; sensors each of which senses a user entering or exiting one of the shared spaces; and a server which is connected to the apparatuses and the sensors via a network, the server comprising:

an energy consumption quantity information receiving unit which receives energy consumption quantity information indicating an energy consumption quantity per unit time from each of the apparatuses;

an entering/exiting information receiving unit which receives, from each of the sensors, entering/exiting information indicating a user entering or exiting a corresponding one of the shared spaces;

a storage unit which stores calculation method information indicating a calculation method for calculating an energy consumption quantity per unit time per user in each of the shared spaces as an estimated consumption quantity;

a calculation method determination unit which determines, based on the calculation method information and the entering/exiting information, the calculation method for calculating the estimated consumption quantity in such a way that the estimated consumption quantity of each user who has entered an energy-saving space, which is the shared space provided with the apparatus having a smaller energy consumption quantity than that of the apparatus provided in a different one of the shared spaces, is to be smaller than the estimated consumption quantity of each user who has entered a non-energy-saving space, which is the shared space provided with the apparatus having a larger energy consumption quantity than that of the apparatus provided in the energy-saving space; and

an estimated consumption quantity calculation unit which calculates the estimated consumption quantity of each user based on the entering/exiting information and the energy consumption quantity information by the calculation method determined by the calculation method determination unit.

(Supplementary Note 2) The estimated consumption quantity calculation system according to the Supplementary Note 1, wherein

the calculation method indicated by the calculation method information includes

a first calculation method for calculating the estimated consumption quantity by dividing the energy consumption quantity per unit time of the apparatus provided in the corresponding one of the shared spaces by number of users in the shared space and

a second calculation method for
calculating the estimated consumption quantity of each user who has entered the energy-saving space by calculating a value obtained by multiplying the energy consumption quantity per unit time of the apparatus provided in the energy-saving space by number of all the shared spaces and dividing the calculated value by total number of the users, and
calculating the estimated consumption quantity of each user who has entered the non-energy-saving space by subtracting a value obtained by multiplying the estimated consumption quantity of each user who has entered the energy-saving space by number of the users in the energy-saving space from total of the energy consumption quantities of the apparatuses provided in all the shared spaces, and dividing the value obtained by the subtraction by number of the users in the non-energy-saving space,

the calculation method determination unit determines, based on the ratio of the number of users in the energy-saving space to the total number of users, the calculation method for calculating the estimated consumption quantity to be either the first calculation method or the second calculation method in such a way that the estimated consumption quantity of each user who has entered an energy-saving space is to be smaller than the estimated consumption quantity of each user who has entered a non-energy-saving space, and

the estimated consumption quantity calculation unit calculates the estimated consumption quantity of each user by the first calculation method or the second calculation method determined by the calculation method determination unit.

(Supplementary Note 3) A server connected, via a network, to apparatuses which are provided in respective shared spaces each being usable at a time by a plurality of users and have different energy consumption quantities, and sensors each of which senses a user entering or exiting a corresponding one of the shared spaces, the server comprising:

an energy consumption quantity information receiving unit which receives energy consumption quantity information indicating an energy consumption quantity per unit time from each of the apparatuses;

an entering/exiting information receiving unit which receives, from each of the sensors, entering/exiting information indicating a user entering or exiting a corresponding one of the shared spaces;

a storage unit which stores calculation method information indicating a calculation method for calculating an energy consumption quantity per unit time per user in each of the shared spaces as an estimated consumption quantity;

a calculation method determination unit which determines, based on the calculation method information and the entering/exiting information, the calculation method for calculating the estimated consumption quantity in such a way that the estimated consumption quantity of each user who has entered an energy-saving space, which is the shared space provided with the apparatus having a smaller energy consumption quantity than that of the apparatus provided in a different one of the shared spaces, is to be smaller than the estimated consumption quantity of each user who has entered a non-energy-saving space, which is the shared space provided with the apparatus having a larger energy consumption quantity than that of the apparatus provided in the energy-saving space; and

an estimated consumption quantity calculation unit which calculates the estimated consumption quantity of each user based on the entering/exiting information and the energy consumption quantity information by the calculation method determined by the calculation method determination unit.

(Supplementary Note 4) The server according to the Supplementary Note 3, wherein

the calculation method indicated by the calculation method information includes

a first calculation method for calculating the estimated consumption quantity by dividing the energy consumption quantity per unit time of the apparatus provided in the corresponding one of the shared spaces by number of users in the shared space and

a second calculation method for
calculating the estimated consumption quantity of each user who has entered the energy-saving space by calculating a value obtained by multiplying the energy consumption quantity per unit time of the apparatus provided in the energy-saving space by number of all the shared spaces and dividing the calculated value by total number of the users, and
calculating the estimated consumption quantity of each user who has entered the non-energy-saving space by subtracting a value obtained by multiplying the estimated consumption quantity of each user who has entered the energy-saving space by number of the users in the energy-saving space from total of the energy consumption quantities of the apparatuses provided in all the shared spaces, and dividing the value obtained by the subtraction by number of the users in the non-energy-saving space,

the calculation method determination unit determines, based on the ratio of the number of users in the energy-saving space to the total number of users, the calculation method for calculating the estimated consumption quantity to be either the first calculation method or the second calculation method in such a way that the estimated consumption quantity of each user who has entered an energy-saving space is to be smaller than the estimated consumption quantity of each user who has entered a non-energy-saving space, and

the estimated consumption quantity calculation unit calculates the estimated consumption quantity of each user by the first calculation method or the second calculation method determined by the calculation method determination unit.

(Supplementary Note 5) An estimated consumption quantity calculation method executed by a server connected, via a network, to apparatuses which are provided in respective shared spaces each being usable at a time by a plurality of users and have different energy consumption quantities, and sensors each of which senses a user entering or exiting a corresponding one of the shared spaces, the method comprising:

an energy consumption quantity information receiving step of receiving energy consumption quantity information indicating an energy consumption quantity per unit time from each of the apparatuses;

an entering/exiting information receiving step of receiving, from each of the sensors, entering/exiting information indicating a user entering or exiting a corresponding one of the shared spaces;

a calculation method determination step of determining, based on calculation method information indicating a calculation method for calculating an energy consumption quantity per unit time per user in each of the shared spaces as an estimated consumption quantity and the entering/exiting information, the calculation method for calculating the estimated consumption quantity in such a way that the estimated consumption quantity of each user who has entered an energy-saving space, which is the shared space provided with the apparatus having a smaller energy consumption quantity than that of the apparatus provided in a different one of the shared spaces, is to be smaller than the estimated consumption quantity of each user who has entered a non-energy-saving space, which is the shared space provided with the apparatus having a larger energy consumption quantity than that of the apparatus provided in the energy-saving space; and

an estimated consumption quantity calculation unit which calculates the estimated consumption quantity of each user based on the entering/exiting information and the energy consumption quantity information by the calculation method determined in the calculation method determination step.

(Supplementary Note 6) The estimated consumption quantity calculation method according to the Supplementary Note 5, wherein

the calculation method indicated by the calculation method information includes

a first calculation method for calculating the estimated consumption quantity by dividing the energy consumption quantity per unit time of the apparatus provided in the corresponding one of the shared spaces by number of users in the shared space and

a second calculation method for
calculating the estimated consumption quantity of each user who has entered the energy-saving space by calculating a value obtained by multiplying the energy consumption quantity per unit time of the apparatus provided in the energy-saving space by number of all the shared spaces and dividing the calculated value by total number of the users, and
calculating the estimated consumption quantity of each user who has entered the non-energy-saving space by subtracting a value obtained by multiplying the estimated consumption quantity of each user who has entered the energy-saving space by number of the users in the energy-saving space from total of the energy consumption quantities of the apparatuses provided in all the shared spaces, and dividing the value obtained by the subtraction by number of the users in the non-energy-saving space,

the calculation method determination unit determines, based on the ratio of the number of users in the energy-saving space to the total number of users, the calculation method for calculating the estimated consumption quantity to be either the first calculation method or the second calculation method in such a way that the estimated consumption quantity of each user who has entered an energy-saving space is to be smaller than the estimated consumption quantity of each user who has entered a non-energy-saving space, and

the estimated consumption quantity calculation unit calculates the estimated consumption quantity of each user by the first calculation method or the second calculation method determined by the calculation method determination unit.

(Supplementary Note 7) A computer-readable recording medium storing a program for causing a computer connected, via a network, to apparatuses which are provided in respective shared spaces each usable at a time by a plurality of users and have different energy consumption quantities, and sensors each of which senses a user entering or exiting a corresponding one of the shared spaces, to function as:

an energy consumption quantity information receiving unit which receives energy consumption quantity information indicating an energy consumption quantity per unit time from each of the apparatuses;

an entering/exiting information receiving unit which receives, from each of the sensors, entering/exiting information indicating a user entering or exiting a corresponding one of the shared spaces;

a storage unit which stores calculation method information indicating a calculation method for calculating an energy consumption quantity per unit time per user in each of the shared spaces as an estimated consumption quantity;

a calculation method determination unit which determines, based on the calculation method information and the entering/exiting information, the calculation method for calculating the estimated consumption quantity in such a way that the estimated consumption quantity of each user who has entered an energy-saving space, which is the shared space provided with the apparatus having a smaller energy consumption quantity than that of the apparatus provided in a different one of the shared spaces, is to be smaller than the estimated consumption quantity of each user who has entered a non-energy-saving space, which is the shared space provided with the apparatus having a larger energy consumption quantity than that of the apparatus provided in the energy-saving space; and

an estimated consumption quantity calculation unit which calculates the estimated consumption quantity of each user based on the entering/exiting information and the energy consumption quantity information by the calculation method determined by the calculation method determination unit.

(Supplementary Note 8) The computer-readable recording medium according to the Supplementary Note 7, wherein

the calculation method indicated by the calculation method information includes

a first calculation method for calculating the estimated consumption quantity by dividing the energy consumption quantity per unit time of the apparatus provided in the corresponding one of the shared spaces by number of users in the shared space and

a second calculation method for
calculating the estimated consumption quantity of each user who has entered the energy-saving space by calculating a value obtained by multiplying the energy consumption quantity per unit time of the apparatus provided in the energy-saving space by number of all the shared spaces and dividing the calculated value by total number of the users, and
calculating the estimated consumption quantity of each user who has entered the non-energy-saving space by subtracting a value obtained by multiplying the estimated consumption quantity of each user who has entered the energy-saving space by number of the users in the energy-saving space from total of the energy consumption quantities of the apparatuses provided in all the shared spaces, and dividing the value obtained by the subtraction by number of the users in the non-energy-saving space,

the calculation method determination unit determines, based on the ratio of the number of users in the energy-saving space to the total number of users, the calculation method for calculating the estimated consumption quantity to be either the first calculation method or the second calculation method in such a way that the estimated consumption quantity of each user who has entered an energy-saving space is to be smaller than the estimated consumption quantity of each user who has entered a non-energy-saving space, and

the estimated consumption quantity calculation unit calculates the estimated consumption quantity of each user by the first calculation method or the second calculation method determined by the calculation method determination unit.

Various exemplary embodiments and modifications are possible for the present invention without departing from the broad spirit and scope of the present invention. The above-described exemplary embodiments are provided merely for illustrating the present invention and are not to limit the scope of the present invention. The scope of the present invention is defined by the scope of claims, not by the exemplary embodiments. Various modifications made within the scope of claims and the significance of the present invention equivalent to the scope of claims are also considered to be within the scope of the present invention.

The present invention is based on Japanese Patent Application No. 2013-167083, filed on Aug. 9, 2013. The description, the scope of claims, and all the drawings of Japanese Patent Application No. 2013-167083 are incorporated herein by reference.

### REFERENCE SIGNS LIST

1 server
2A, 2B air conditioner
3A, 3B sensor
11 power consumption quantity information receiving unit
12 user information receiving unit
13 storage unit
14 mode determination unit
15 estimated consumption quantity computation unit
16 estimated consumption quantity output unit
41 control unit
42 main storage unit
43 external storage unit
44 operation unit
43 display unit
46 transceiver unit
49 control program
100 estimated consumption quantity calculation system

1. An estimated consumption quantity calculation system comprising: apparatuses which are provided in respective shared spaces each being usable at a time by a plurality of users and have different energy consumption quantities; sensors each of which senses a user entering or exiting one of the shared spaces; and a server which is connected to the apparatuses and the sensors via a network, the server comprising:
an energy consumption quantity information receiving unit which receives energy consumption quantity information indicating an energy consumption quantity per unit time from each of the apparatuses;
an entering/exiting information receiving unit which receives, from each of the sensors, entering/exiting information indicating a user entering or exiting a corresponding one of the shared spaces;
a storage unit which stores calculation method information indicating a calculation method for calculating an energy consumption quantity per unit time per user in each of the shared spaces as an estimated consumption quantity;
a calculation method determination unit which determines, based on the calculation method information and the entering/exiting information, the calculation method for calculating the estimated consumption quantity in such a way that the estimated consumption quantity of each user who has entered an energy-saving space, which is the shared space provided with the apparatus having a smaller energy consumption quantity than that of the apparatus provided in a different one of the shared spaces, is to be smaller than the estimated consumption quantity of each user who has entered a non-energy-saving space, which is the shared space provided with the apparatus having a larger energy consumption quantity than that of the apparatus provided in the energy-saving space; and
an estimated consumption quantity calculation unit which calculates the estimated consumption quantity of each user based on the entering/exiting information and the energy consumption quantity information by the calculation method determined by the calculation method determination unit.

2. The estimated consumption quantity calculation system according to claim 1, wherein
the calculation method indicated by the calculation method information includes
a first calculation method for calculating the estimated consumption quantity by dividing the energy consumption quantity per unit time of the apparatus provided in the corresponding one of the shared spaces by number of users in the shared space and
a second calculation method for
calculating the estimated consumption quantity of each user who has entered the energy-saving space by calculating a value obtained by multiplying the energy consumption quantity per unit time of the apparatus provided in the energy-saving space by number of all the shared spaces and dividing the calculated value by total number of the users, and
calculating the estimated consumption quantity of each user who has entered the non-energy-saving space by subtracting a value obtained by multiplying the estimated consumption quantity of each user who has entered the energy-saving space by number of the users in the energy-saving space from total of the energy consumption quantities of the apparatuses provided in all the shared spaces, and dividing the value obtained by the subtraction by number of the users in the non-energy-saving space,
the calculation method determination unit determines, based on the ratio of the number of users in the energy-saving space to the total number of users, the calculation method for calculating the estimated consumption quantity to be either the first calculation method or the second calculation method in such a way that the estimated consumption quantity of each user who has entered an energy-saving space is to be smaller than the estimated consumption quantity of each user who has entered a non-energy-saving space, and
the estimated consumption quantity calculation unit calculates the estimated consumption quantity of each user by the first calculation method or the second calculation method determined by the calculation method determination unit.

3. A server connected, via a network, to apparatuses which are provided in respective shared spaces each being usable at a time by a plurality of users and have different energy consumption quantities, and sensors each of which senses a user entering or exiting a corresponding one of the shared spaces, the server comprising:
an energy consumption quantity information receiving unit which receives energy consumption quantity information indicating an energy consumption quantity per unit time from each of the apparatuses;
an entering/exiting information receiving unit which receives, from each of the sensors, entering/exiting information indicating a user entering or exiting a corresponding one of the shared spaces;
a storage unit which stores calculation method information indicating a calculation method for calculating an energy consumption quantity per unit time per user in each of the shared spaces as an estimated consumption quantity;
a calculation method determination unit which determines, based on the calculation method information and the entering/exiting information, the calculation method for calculating the estimated consumption quantity in such a way that the estimated consumption quantity of each user who has entered an energy-saving space, which is the shared space provided with the apparatus having a smaller energy consumption quantity than that of the apparatus provided in a different one of the shared spaces, is to be smaller than the estimated consumption quantity of each user who has entered a non-energy-saving space, which is the shared space provided with the apparatus having a larger energy consumption quantity than that of the apparatus provided in the energy-saving space; and
an estimated consumption quantity calculation unit which calculates the estimated consumption quantity of each user based on the entering/exiting information and the energy consumption quantity information by the calculation method determined by the calculation method determination unit.

4. An estimated consumption quantity calculation method executed by a server connected, via a network, to apparatuses which are provided in respective shared spaces each being usable at a time by a plurality of users and have different energy consumption quantities, and sensors each of which senses a user entering or exiting a corresponding one of the shared spaces, the method comprising:
an energy consumption quantity information receiving step of receiving energy consumption quantity information indicating an energy consumption quantity per unit time from each of the apparatuses;
an entering/exiting information receiving step of receiving, from each of the sensors, entering/exiting information indicating a user entering or exiting a corresponding one of the shared spaces;
a calculation method determination step of determining, based on calculation method information indicating a calculation method for calculating an energy consumption quantity per unit time per user in each of the shared spaces as an estimated consumption quantity and the entering/exiting information, the calculation method for calculating the estimated consumption quantity in such a way that the estimated consumption quantity of each user who has entered an energy-saving space, which is the shared space provided with the apparatus having a smaller energy consumption quantity than that of the apparatus provided in a different one of the shared spaces, is to be smaller than the estimated consumption quantity of each user who has entered a non-energy-saving space, which is the shared space provided with the apparatus having a larger energy consumption quantity than that of the apparatus provided in the energy-saving space; and
an estimated consumption quantity calculation unit which calculates the estimated consumption quantity of each user based on the entering/exiting information and the energy consumption quantity information by the calculation method determined in the calculation method determination step.

5. A non-transitory computer readable recording medium storing a program for causing a computer connected, via a network, to apparatuses which are provided in respective shared spaces each usable at a time by a plurality of users and have different energy consumption quantities, and sensors each of which senses a user entering or exiting a corresponding one of the shared spaces, to function as:
an energy consumption quantity information receiving unit which receives energy consumption quantity information indicating an energy consumption quantity per unit time from each of the apparatuses;
an entering/exiting information receiving unit which receives, from each of the sensors, entering/exiting information indicating a user entering or exiting a corresponding one of the shared spaces;
a storage unit which stores calculation method information indicating a calculation method for calculating an energy consumption quantity per unit time per user in each of the shared spaces as an estimated consumption quantity;
a calculation method determination unit which determines, based on the calculation method information and the entering/exiting information, the calculation method for calculating the estimated consumption quantity in such a way that the estimated consumption quantity of each user who has entered an energy-saving space, which is the shared space provided with the apparatus having a smaller energy consumption quantity than that of the apparatus provided in a different one of the shared spaces, is to be smaller than the estimated consumption quantity of each user who has entered a non-energy-saving space, which is the shared space provided with the apparatus having a larger energy consumption quantity than that of the apparatus provided in the energy-saving space; and
an estimated consumption quantity calculation unit which calculates the estimated consumption quantity of each user based on the entering/exiting information and the energy consumption quantity information by the calculation method determined by the calculation method determination unit.
